(19) United States
(12) Patent Application Publication
(10) Pub. No.: US 2025/0361173 A1
(43) Pub. Date: Nov. 27, 2025

(54) GLASS CERAMIC, CHEMICALLY STRENGTHENED GLASS CERAMIC, AND METHOD FOR TESTING GLASS CERAMIC

(71) Applicant: AGC Inc., Tokyo (JP)

(72) Inventors: Kaname SEKIYA, Tokyo (JP); Hiroyuki HIJIYA, Tokyo (JP)

(73) Assignee: AGC Inc., Tokyo (JP)

(21) Appl. No.: 19/218,727

(22) Filed: May 27, 2025

(30) Foreign Application Priority Data
May 27, 2024 (JP) 2024-085839

(51) Int. Cl. C03C 10/00; G01N 25/72

(52) U.S. Cl. CPC C03C 10/0027; G01N 25/72; C03C 2214/20

(57) ABSTRACT

The present invention relates to a glass ceramic having a base composition including, in mol % in terms of oxides, 60% to 75% of SiO₂, 3% to 20% of Al₂O₃, and 5% to 25% of Li₂O, in which an average linear expansion coefficient at 250° C. to 350° C. is 90×10⁻⁷ [/K] or less, and when the glass ceramic is immersed in hot water at 80° C. for 120 minutes, a mass change amount per surface area from a mass of the glass ceramic before immersion is 1500 μg/cm² or less.

### CROSS-REFERENCE TO RELATED APPLICATIONS

The present application claims priority from Japanese Patent Application No. 2024-085839 filed on May 27, 2024, the entire contents of which are hereby incorporated by reference.

### TECHNICAL FIELD

The present invention relates to a glass ceramic, a chemically strengthened glass ceramic, and a method for testing a glass ceramic, and more particularly, to a glass ceramic that can be chemically strengthened, a chemically strengthened glass ceramic, and a method for testing a glass ceramic.

### BACKGROUND ART

A chemically strengthened glass is used for a cover glass or the like of a mobile terminal. The chemically strengthened glass is obtained by, for example, bringing a glass into contact with a molten salt containing alkali metal ions to cause ion exchange between the alkali metal ions in the glass and alkali metal ions in the molten salt, thereby forming a compressive stress layer on the glass surface.

In recent years, a glass ceramic has been used as a high strength material as a base material of such a chemically strengthened glass. A glass ceramic is obtained by precipitating a crystal in the glass, and is harder and less likely to be scratched than an amorphous glass containing no crystal. In addition, the glass ceramic capable of being chemically strengthened can have high strength while preventing crushing compared to the amorphous glass. Patent Literatures 1 and 2 describe examples in which a glass ceramic is subjected to an ion exchange treatment to be chemically strengthened.

### CITATION LIST

### Patent Literature

Patent Literature 1: WO 2019/022035

Patent Literature 2: US2020/0017398A1

### SUMMARY OF INVENTION

The glass ceramic has different configurations, such as the type of crystals precipitated within the structure, depending on a composition and a production method, and different drop strength properties and weather resistance properties depending on the difference in configuration. The glass ceramic having a poor weather resistance property has a problem that a surface state is likely to deteriorate due to an environmental load, and thus surface strength is likely to decrease.

Therefore, an object of the present invention is to provide a glass ceramic and a chemically strengthened glass ceramic having excellent weather resistance.

As a result of examining the above problems, the inventors of the present invention have found that a glass ceramic having a composition and a mass change amount per surface area in a hot water immersion test within specific ranges has excellent weather resistance, and have completed the present invention.

That is, the present disclosure is as follows.
1. A glass ceramic having a base composition including, in mol % in terms of oxides, 60% to 75% of SiO₂, 3% to 20% of Al₂O₃, and 5% to 25% of Li₂O, in which
an average linear expansion coefficient at 250° C. to 350° C. is 90×10⁻⁷ [/K] or less, and
when the glass ceramic is immersed in hot water at 80° C. for 120 minutes, a mass change amount per surface area from a mass of the glass ceramic before immersion is 1500 μg/cm² or less.
2. The glass ceramic according to the above 1, including at least one selected from the group consisting of Li₂Si₂O₅, LiAlSi₂O₆, LiAlSi₄O₁₀, Li₃PO₄, and a β-quartz solid solution as a crystal seed.
3. The glass ceramic according to the above 1, in which a Young's modulus is 70 GPa or more.
4. The glass ceramic according to the above 1, in which a mass change rate is 1000 ppm or less when the glass ceramic is immersed in hot water at 80° C. for 120 minutes.
5. The glass ceramic according to the above 1, in which the base composition includes, in mol % in terms of oxides, 60% to 75% of SiO₂, 3% to 20% of Al₂O₃, more than 0% and 4.0% or less of P₂O₅, 5% to 25% of Li₂O, 0% to 2.0% of Na₂O, 0% to 1% of K₂O, 0% to 5% of MgO, 0% to 2% of CaO, and more than 0% and 5% or less of ZrO₂, in which

X as determined using the following equation is 0.40 or less, provided that,

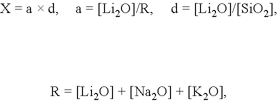

and
a value in [ ] indicates a content, in mol % in terms of oxides, of a component in the parentheses in the base composition.
6. A chemically strengthened glass ceramic having a base composition including, in mol % in terms of oxides, 60% to 75% of SiO₂, 3% to 20% of Al₂O₃, and 5% to 25% of Li₂O, in which
an average linear expansion coefficient at 250° C. to 350° C. is 90×10⁻⁷ [/K] or less, and
when the chemically strengthened glass ceramic is immersed in hot water at 80° C. for 120 minutes, a mass change amount per surface area from a mass of the chemically strengthened glass ceramic before immersion is 8000 μg/cm² or less.
7. The chemically strengthened glass ceramic according to the above 6, in which
   a sheet thickness is t (mm),
   a compressive stress layer depth DOC is 0.14 t (μm) or more,
   a surface compressive stress value CS₀ is 400 MPa or more,
   a compressive stress value CS₅₀ at a depth of 50 μm from a surface of the chemically strengthened glass ceramic is 150 t (MPa) or more, and
   a tensile stress value CT is −350 t+400 (MPa) or less.
8. The chemically strengthened glass ceramic according to the above 6, in which a Young's modulus is 70 GPa or more.
9. The chemically strengthened glass ceramic according to the above 6, in which the base composition includes, in mol % in terms of oxides, 60% to 75% of SiO₂, 3% to 20% of Al₂O₃, more than 0% and 4.0% or less of P₂O₅, 5% to 25% of Li₂O, 0% to 2.0% of Na₂O, 0% to 1% of K₂O, 0% to 5% of MgO, 0% to 2% of CaO, and more than 0% and 5% or less of ZrO₂, in which
X as determined using the following equation is 0.40 or less, provided that,

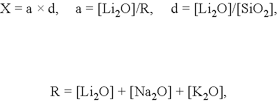

and
a value in [ ] indicates a content, in mol % in terms of oxides, of a component in the parentheses in the base composition.
10. A method for testing a glass ceramic, the method including:
   immersing a glass ceramic in hot water at 80° C. for 120 minutes to measure a mass change amount per surface area from a mass of the glass ceramic before immersion; and
   determining that the glass ceramic is an acceptable product in a case where the mass change amount per surface area is 1500 μg/cm² or less.
11. A method for testing a chemically strengthened glass ceramic, the method including:
   immersing a chemically strengthened glass ceramic in hot water at 80° C. for 120 minutes to measure a mass change amount per surface area from a mass of the chemically strengthened glass ceramic before immersion; and
   determining that the chemically strengthened glass ceramic is an acceptable product in a case where the mass change amount per surface area is 8000 μg/cm² or less.

The glass ceramic and the chemically strengthened glass ceramic according to the present disclosure have a composition and a mass change amount per surface area in a hot water immersion test within specific ranges, and have excellent weather resistance. Accordingly, there is an advantage that a surface state is less likely to deteriorate due to an environmental load, and surface strength is less likely to decrease.

With the method for testing a glass ceramic according to the present disclosure, a glass ceramic that has excellent weather resistance and that is less likely to decrease in surface strength due to an environmental load can be efficiently selected. With the method for testing a chemically strengthened glass ceramic according to the present disclosure, a chemically strengthened glass ceramic that has excellent weather resistance and that is less likely to decrease in surface strength due to an environmental load can be efficiently selected.

### BRIEF DESCRIPTION OF DRAWINGS

FIG. 1 shows a mass change amount per surface area when a glass material is immersed in hot water at 80° C. (immersion time: 30 minutes or 120 minutes).

FIG. 2 shows results of measuring surface strength by a BoR strength test after the glass material is immersed in hot water at 80° C. for 120 minutes.

FIG. 3 shows a correlation between an average linear expansion coefficient at 250° C. to 350° C. and a mass change rate in the hot water immersion test.

FIG. 4 is a schematic diagram illustrating the ball on ring test method.

### DESCRIPTION OF EMBODIMENTS

Hereinafter, the present invention is described with reference to embodiments, but the present invention is not limited to the embodiments. In the present specification, “to” indicating a numerical range is used in the sense of including the numerical values set forth before and after the “to” as a lower limit value and an upper limit value, unless otherwise specified.

A “glass ceramic” is obtained by subjecting an “amorphous glass” to a heat treatment to precipitate crystals, and contains crystals. In the present specification, the “amorphous glass” refers to a glass in which no diffraction peak indicating a crystal is observed by a powder X-ray diffraction method to be described later. In the present specification, the “amorphous glass” and the “glass ceramic” may be collectively referred to as a “glass”. The amorphous glass that becomes a glass ceramic by the heat treatment may be referred to as a “base glass of the glass ceramic”.

In the present specification, in powder X-ray diffraction measurement, for example, 2θ is measured in a range of 10° to 80° using a CuKα ray, and in the case where a diffraction peak appears, precipitated crystals are identified by a Hanawalt method. In addition, a crystal identified from a peak group including a peak having the highest integrated intensity among the crystals identified by this method is defined as a main crystal. For example, Smart Lab manufactured by Rigaku Corporation can be used as a measurement device.

In the present specification, a “residual glass” refers to an amorphous portion that is not crystallized in the glass ceramic.

In the present specification, a “chemically strengthened glass” refers to a glass after being subjected to a chemical strengthening treatment, and a “glass for chemical strengthening” refers to a glass before being subjected to a chemical strengthening treatment. In the present embodiment, a “chemically strengthened glass ceramic” refers to a glass ceramic after being subjected to a chemical strengthening treatment.

In the present specification, a glass composition is expressed in mol % in terms of oxides unless otherwise specified, and mol % is simply expressed as “%”.

In the present specification, “not substantially contained” means that a component has a content equal to or less than an impurity level contained in raw materials and the like, that is, the component is not intentionally added. Specifically, the content is less than 0.1%, for example.

### 1. Glass Ceramic

A glass ceramic according to the present embodiment (hereinafter referred to as the present glass ceramic) has a base composition including, in mol % in terms of oxides, 60% to 75% of SiO₂, 3% to 20% of Al₂O₃, and 5% to 25% of Li₂O, in which an average linear expansion coefficient at 250° C. to 350° C. is 90×10^{-7 [/}K] or less, and when the glass ceramic is immersed in hot water at 80° C. for 120 minutes, a mass change amount from a mass before immersion is 1500 μg/cm² or less.

### (Mass Change Amount Per Surface Area in Hot Water Immersion Test, and Mass Change Rate in Hot Water Immersion Test)

In the present specification, the “mass change amount per surface area in the hot water immersion test” refers to a value obtained by dividing, by the surface area, the mass change amount from the mass before immersion when the glass ceramic is immersed in hot water at 80° C. for 120 minutes.

In the present specification, the “mass change rate in the hot water immersion test” refers to a mass change rate from the mass before immersion when the glass is immersed in hot water at 80° C. for 120 minutes.

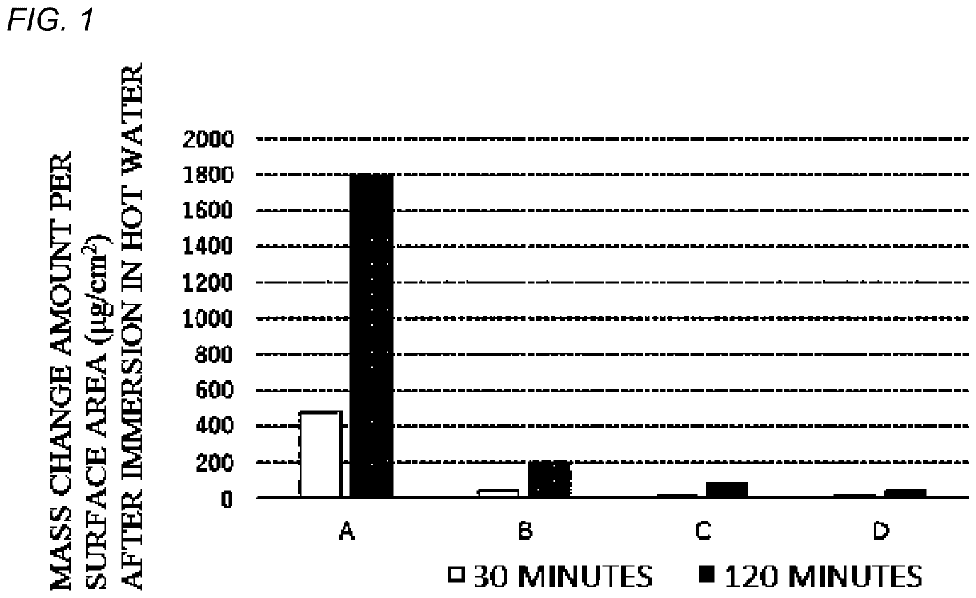

The inventors of the present invention have found that there is a correlation between the mass change amount per surface area compared to the mass before immersion when the glass is immersed in hot water and surface strength after immersion in hot water, as shown in FIG. 1. As shown in FIG. 1, the mass change amount per surface area when the glass is immersed in hot water varies depending on a composition and a structure of a glass material (a glass ceramic or an amorphous glass, or a crystal seed contained in the glass ceramic), and the mass change amount of the glass ceramic is larger than that of the amorphous glass.

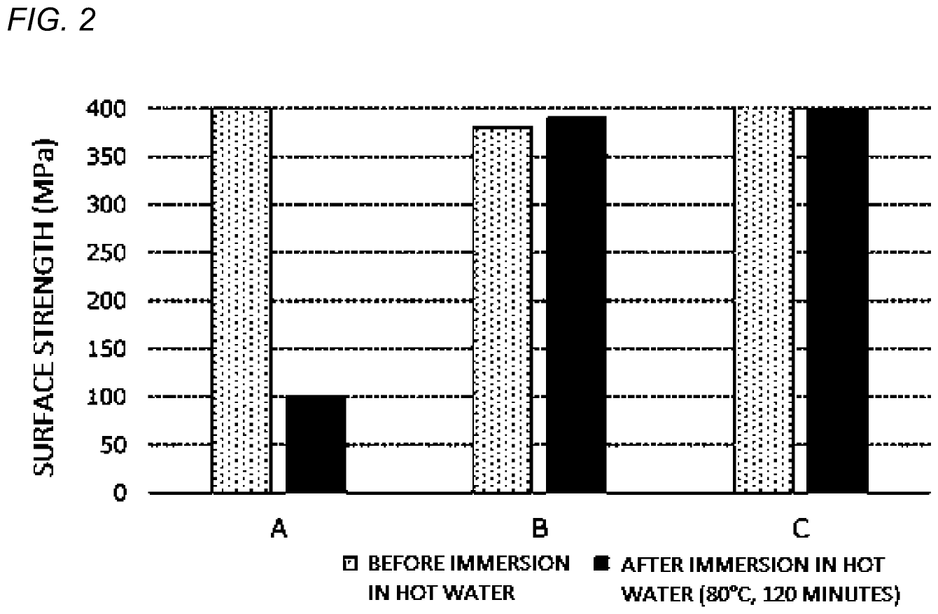

Further, the inventors of the present invention have found that there is a correlation between the mass change amount per surface area compared to the mass before immersion when the glass is immersed in hot water at 80° C. for 120 minutes and the surface strength after immersion in hot water at 80° C. for 120 minutes, as shown in FIG. 2. Therefore, it is considered that when the glass is immersed in hot water at 80° C. for 120 minutes, the mass change amount per surface area compared to the mass before immersion is used as an index, whereby weather resistance of the glass can be improved, and a decrease in surface strength due to an environmental load can be controlled.

The present glass ceramic has a mass change amount compared to the mass before immersion when immersed in hot water at 80° C. for 120 minutes (hereinafter, also abbreviated as a mass change amount per surface area in a hot water immersion test) of 1500 μg/cm² or less. When the mass change amount per surface area in the hot water immersion test is 1500 μg/cm² or less, the weather resistance can be improved, and a decrease in surface strength due to an environmental load can be prevented.

The mass change amount per surface area in the hot water immersion test for the present glass ceramic is more preferably 1500 μg/cm² or less, still more preferably 800 μg/cm² or less, particularly preferably 500 μg/cm² or less, and most preferably 100 μg/cm² or less. The lower limit value of the mass change amount per surface area in the hot water immersion test is not particularly limited, and may be 0 μg/cm².

The mass change rate in the hot water immersion test for the present glass ceramic is preferably 1000 ppm or less, more preferably 500 ppm or less, still more preferably 300 ppm or less, particularly preferably 100 ppm or less, and most preferably 50 ppm or less, from the viewpoint of further improving the weather resistance and preventing a decrease in surface strength due to an environmental load. The lower limit value of the mass change rate in the hot water immersion test is not particularly limited, and may be 0 ppm.

The mass change rate in the hot water immersion test can be adjusted based on a linear expansion coefficient, the glass base composition, crystallization conditions, a crystal seed, a crystallinity, and the like.

### (Linear Expansion Coefficient)

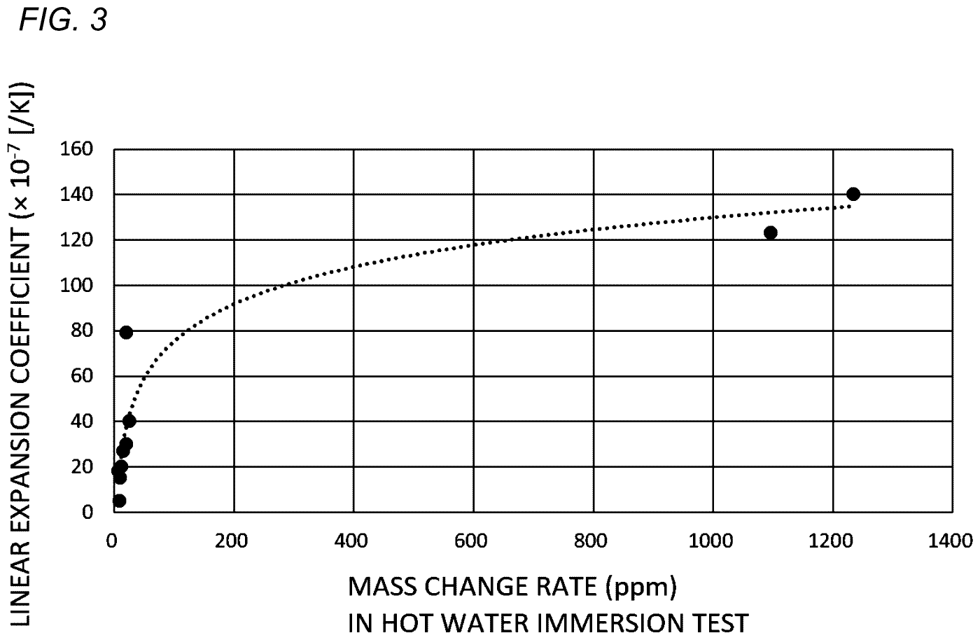

The present glass ceramic has an average linear expansion coefficient at 250° C. to 350° C. of 90×10⁻⁷ [/K] or less. FIG. 3 shows a correlation between the average linear expansion coefficient at 250° C. to 350° C. (represented as “average linear expansion coefficient” in FIG. 3) and the mass change rate in the hot water immersion test. In FIG. 3, the horizontal axis represents the mass change rate (ppm) in the hot water immersion test, and the vertical axis represents the average linear expansion coefficient (×10⁻⁷ [/K]) at 250° C. to 350° C. As shown in FIG. 3, it can be seen that the average linear expansion coefficient at 250° C. to 350° C. and the mass change rate in the hot water immersion test have a correlation, and when the average linear expansion coefficient at 250° C. to 350° C. is more than 90×10⁻⁷ [/K], the mass change rate in the hot water immersion test increases. When the average linear expansion coefficient at 250° C. to 350° C. is large, the glass contains a crystal seed having weak network connection, and the glass is easily immersed and easily collapsed, which causes a mass reduction. Therefore, it is considered that the mass change rate in the hot water immersion test increases as the average linear expansion coefficient at 250° C. to 350° C. increases.

Since the present glass ceramic has an average linear expansion coefficient at 250° C. to 350° C. of 90×10⁻⁷ [/K] or less, the mass change rate in the hot water immersion test can be reduced, the weather resistance of the glass can be improved, and a decrease in surface strength due to an environmental load can be prevented. The average linear expansion coefficient at 250° C. to 350° C. is preferably 70×10⁻⁷ [/K] or less, more preferably 50×10⁻⁷ [/K] or less, still more preferably 30×10⁻⁷ [/K] or less, and particularly preferably 10×10⁻⁷ [/K] or less. The lower limit of the average linear expansion coefficient at 250° C. to 350° C. is not particularly limited. The average linear expansion coefficient at 250° C. to 350° C. can be adjusted based on the glass base composition, the crystallization conditions, the crystal seed, the crystallinity, and the like.

### (Crystal Seed)

The present glass ceramic preferably contains, as a crystal seed, at least one selected from the group consisting of Li₂Si₂O₅, LiAlSi₂O₆, LiAlSi₄O₁₀, Li₃PO₄, and a β-quartz solid solution, and more preferably contains at least one selected from the group consisting of Li₂Si₂O₅, LiAlSi₂O₆, and a β-quartz solid solution. Solid solution crystals thereof may be contained. Since these crystal seed have a small linear expansion coefficient, the mass change amount per surface area in the hot water immersion test can be reduced, and the weather resistance can be further improved.

In the present glass ceramic, a ratio (Si/Li) of a molar content of Si to Li in the main

crystal is preferably 0.9 to 5.0 from the viewpoint of further reducing the mass change amount per surface area in the hot water immersion test. The ratio (Si/Li) in the main crystal is preferably 1.0 or more, more preferably 1.2 or more, still more preferably 1.4 or more, and particularly preferably 1.6 or more, from the viewpoint of further reducing the mass change amount per surface area in the hot water immersion test. The ratio (Si/Li) in the main crystal is preferably 4.0 or less, more preferably 3.0 or less, and still more preferably 2.5 or less, from the viewpoint of improving chemical resistance of the glass.

In the present glass ceramic, a ratio (Al/Li) of a molar content of Al to Li in the main

crystal is preferably more than 0 from the viewpoint of further reducing the mass change amount per surface area in the hot water immersion test. The ratio (Al/Li) in the main crystal is preferably more than 0, more preferably 0.5 or more, still more preferably 0.75 or more, and particularly preferably 1 or more, from the viewpoint of further reducing the mass change amount per surface area in the hot water immersion test. The upper limit of the numerical value of the ratio (Al/Li) is not particularly limited.

The ratio (Si/Li) of Si to Li and the ratio (Al/Li) of Al to Li in the main crystal are determined based on a chemical formula of the main crystal. For example, in the case where the main crystal is LiAlSi₂O₆, (Si/Li) is 2.0, and (Al/Li) is 1.0. In the case where the main crystal is Li₂Si₂O₅, (Si/Li) is 1.0, and (Al/Li) is 0.

### (Crystallinity)

The present glass ceramic has a crystallinity of preferably 50% or more, more preferably 60% or more, and still more preferably 70% or more. When the crystallinity is 50% or more, the mass change amount per surface area in the hot water immersion test can be reduced, the weather resistance can be further improved, and the strength can be increased. The crystallinity is preferably 97% or less, more preferably 95% or less, and still more preferably 90% or less, from the viewpoint of ensuring transparency. The crystallinity can be calculated by measuring powder X-ray diffraction and using a Rietveld method.

An average particle diameter of precipitated crystals of the present glass ceramic is preferably 5 nm or more, and particularly preferably 10 nm or more. The average particle diameter is preferably 100 nm or less, more preferably 50 nm or less, and still more preferably 30 nm or less, in order to improve the transparency. The average particle diameter of the precipitated crystals is determined based on a transmission electron microscope (TEM) image. (Young's Modulus)

The present glass ceramic has a Young's modulus of preferably 70 GPa or more, more preferably 80 GPa or more, still more preferably 85 GPa or more, and particularly preferably 90 GPa or more. When the Young's modulus is 70 GPa or more, rigidity of the glass can be improved, and the strength can be increased. The Young's modulus is preferably 120 GPa or less, more preferably 110 GPa or less, and still more preferably 105 GPa or less, from the viewpoint of ease of polishing.

### (Fracture Toughness Value)

The present glass ceramic has a fracture toughness value (K_{IC}) of preferably 0.70 MPa·m^{1/2} or more, more preferably 0.80 MPa·m^{1/2} or more, still more preferably 0.85 MPa·m^{1/2} or more, particularly preferably 0.95 MPa·m^{1/2} or more, and most preferably 1.05 MPa·m^{1/2} or more. When the fracture toughness value is 0.70 MPa·m^{1/2} or more, impact resistance is high, and severe fracture hardly occurs even when a large compressive stress is formed by chemical strengthening. The upper limit of the fracture toughness value of the present glass ceramic is not particularly limited, and is typically 1.5 MPa·m^{1/2} or less, for example. In the present specification, the “fracture toughness value” is a value according to the IF method defined in JIS R1607:2015.

### (Surface Strength)

In the present specification, the “surface strength” refers to a value measured by a test under the following conditions (ball on ring strength test, hereinafter also abbreviated as a BoR strength test). BoR Strength Test Conditions:

A glass sheet having a thickness t (mm) is disposed on a stainless ring having a diameter of 30 mm and a rounded contact portion having a radius of curvature of 2.5 mm, in the state where a steel sphere having a diameter of 10 mm is brought into contact with the glass sheet, the sphere is loaded to a center of the ring under a static load condition, a breaking load (unit: N) when the glass is broken is defined as BoR strength, and an average value of measurements of the BoR strength ten times is defined as the surface strength. However, in the case where a glass breaking starting point is 2 mm or more away from the load point of the sphere, it is excluded from the data for calculating the average value.

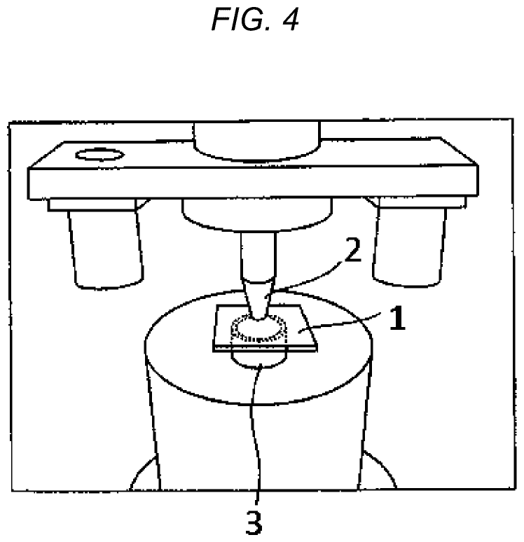

FIG. 4 is a schematic diagram illustrating the ball on ring strength test. In the ball on ring (BoR) test, a glass sheet 1 is pressurized using a SUS304-made pressurizing jig 2 (quenched steel, diameter: 10 mm, mirror finished) in the state where the glass sheet 1 is placed horizontally, and the strength of the glass sheet 1 is measured.

In FIG. 4, the glass sheet 1 as a sample is horizontally placed on a SUS304-made receiving jig 3 (diameter: 30 mm, curvature R of contact portion: 2.5 mm, contact portion:

quenched steel, mirror-finished). The pressurizing jig 2 for pressurizing the glass sheet 1 is installed above the glass sheet 1. In the present embodiment, a central region of the glass sheet 1 is pressurized from above the glass sheet 1.

Note that, the test conditions are as follows. Lowering speed of pressurizing jig 2: 1.0 (mm/min)

At this time, the breaking load (unit: N) when the glass sheet 1 is broken is defined as the BoR strength, and the average value of the measurements of the BoR strength ten times is defined as the surface strength (N). However, in the case where the breaking starting point of the glass sheet 1 is 2 mm or more away from the load point of the sphere, it is excluded from the data for calculating the average value.

The surface strength of the present glass ceramic after immersion in hot water at 80° C. for 120 minutes is preferably 340 N or more, more preferably 360 N or more, still more preferably 380 N or more, and particularly preferably 400 N or more. The upper limit of the surface strength after immersion in hot water at 80° C. for 120 minutes is not particularly limited. (Thickness and Shape)

The thickness (t) of the present glass ceramic having a sheet shape is preferably 0.30 mm to 1.00 mm. The thickness is more preferably 0.90 mm or less, still more preferably 0.80 mm or less, particularly preferably 0.70 mm or less, and most preferably 0.65 mm or less. In addition, the thickness is more preferably 0.35 mm or more, still more preferably 0.40 mm or more, particularly preferably 0.45 mm or more, and most preferably 0.50 mm or more, from the viewpoint of further increasing the strength.

A shape of the present glass ceramic may be a shape other than a sheet shape depending on a product, an application, or the like to which the present glass ceramic is applied. In addition, the present glass ceramic may have an edged shape or the like in which a thickness of an outer periphery is different. The form of the present glass ceramic is not limited thereto, and for example, two main surfaces may not be parallel to each other, and all or a part of one or both of the two main surfaces may be curved surfaces. More specifically, the present glass ceramic may be, for example, a flat sheet-shaped glass sheet having no warpage or a curved glass sheet having a curved surface.

### (Base Composition of Glass Ceramic)

The present glass ceramic contains, as a base composition in mol % in terms of oxides, 60% to 75% of SiO₂, 3% to 20% of Al₂O₃, and 5% to 25% of Li₂O.

The present glass ceramic preferably contains, as a base composition in mol % in terms of oxides, 60% to 75% of SiO₂, 3% to 20% of Al₂O₃, more than 0% and 4.0% or less of P₂O₅, 5% to 25% of Li₂O, 0% to 2.0% of Na₂O, 0% to 1% of K₂O, 0% to 5% of MgO, 0% to 2% of CaO, and more than 0% and 5% or less of ZrO₂, in which X is 0.40 or less as determined using the following equation.

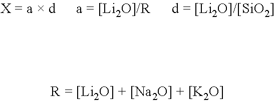

The value in [ ] indicates a content, in mol % in terms of oxides, of the component in the parentheses in the base composition.

Hereinafter, the composition of the present glass ceramic is described.

SiO₂ is a component for forming a glass network structure. The content of SiO₂ is 60% or more, preferably 62% or more, more preferably 64% or more, still more preferably 66% or more, particularly preferably 68% or more, and most preferably 70% or more. On the other hand, the content of SiO₂ is 75% or less, preferably 74% or less, more preferably 73% or less, still more preferably 72% or less, and particularly preferably 70% or less, in order to improve meltability.

Al₂O₃ is a component that increases a surface compressive stress caused by chemical strengthening and is essential. The content of Al₂O₃ is 3% or more, preferably 4% or more, more preferably 5% or more, still more preferably 7% or more, 9% or more, 11% or more, and 13% or more in this order, particularly preferably 14% or more, and most preferably 15% or more. On the other hand, the content of Al₂O₃ is 20% or less, preferably 19% or less, more preferably 18% or less, still more preferably 17% or less, and most preferably 16% or less, in order to prevent a devitrification temperature of the glass from becoming excessively high.

P₂O₅ is a component that can be a constituent component of a crystal, and is preferably contained from the viewpoint of promoting crystallization. The content of P₂O₅ is preferably more than 0%, more preferably 0.5% or more, still more preferably 1.0% or more, particularly preferably 1.5% or more, and most preferably 2.0% or more. On the other hand, when the content of P₂O₅ is too large, phase separation is likely to occur during melting and the weather resistance may decrease, and therefore, the content of P₂O₅ is preferably 4.0% or less, more preferably 3.5% or less, still more preferably 3.0% or less, and particularly preferably 2.5% or less.

Li₂O is a component for forming a surface compressive stress by ion exchange, and is a constituent component of the main crystal, and is thus essential. The content of Li₂O is 5% or more, preferably 7% or more, more preferably 10% or more, more preferably 12% or more, still more preferably 15% or more, particularly preferably 17% or more, and most preferably 19% or more. On the other hand, the content of Li₂O is 25% or less, preferably 23% or less, more preferably 21% or less, and most preferably 20% or less in order to stabilize the glass.

Na₂O is a component that improves the meltability of the glass. Na₂O is not essential, and in the case where Na₂O is contained, the content thereof is preferably 0.5% or more, more preferably 1% or more, and particularly preferably 2% or more. When the content of Na₂O is too large, chemical strengthening properties may decrease, and therefore, the content of Na₂O is preferably 2.0% or less, more preferably 1.8% or less, still more preferably 1.5% or less, and particularly preferably 1.2% or less.

K₂O is a component that lowers a melting temperature of the glass similar to Na₂O and may be contained. In the case where K₂O is contained, the content thereof is preferably 0.1% or more, more preferably 0.2% or more, still more preferably 0.3% or more, and particularly preferably 0.5% or more. When the content of K₂O is too large, the chemical strengthening properties may decrease, and therefore, the content thereof is preferably 1% or less, more preferably 0.8% or less, still more preferably 0.7% or less, and most preferably 0.6% or less.

In the present glass ceramic, X is preferably 0.40 or less as determined using the following equation. When X is 0.40 or less, the mass change amount per surface area in the hot water immersion test can be reduced and the weather resistance can be further improved by strengthening connection of the SiO₂ network of the glass and preventing water immersion.

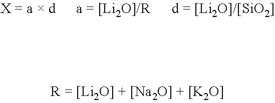

The value in [ ] indicates a content, in mol % in terms of oxides, of the component in the parentheses in the base composition.

X determined using the above equation is more preferably 0.35 or less, still more preferably 0.30 or less, particularly preferably 0.20 or less, and most preferably 0.10 or less. The lower limit of X is not particularly limited, and is, for example, 0.001 or more.

A value of a ([Li₂O] /R) is preferably 1.00 or less, more preferably 0.9 or less, and still more preferably 0.80 or less, from the viewpoint of reducing the mass change amount per surface area in the hot water immersion test. In addition, the value of a is preferably 0.40 or more, more preferably 0.50 or more, and still more preferably 0.60 or more, from the viewpoint of improving ion exchange properties.

A value of d ([Li₂O] /[SiO₂]) is preferably 0.50 or less, more preferably 0.40 or less, and still more preferably 0.30 or less, from the viewpoint of reducing the mass change amount per surface area in the hot water immersion test. In addition, the value of d is preferably 0.05 or more, more preferably 0.10 or more, and still more preferably 0.20 or more, from the viewpoint of improving the chemical strengthening properties.

A value of R ([Li₂O]+[Na₂O]+[K₂O]) is preferably 7.0% or more, more preferably 10.0% or more, and still more preferably 15.0% or more, from the viewpoint of reducing the mass change amount per surface area in the hot water immersion test. In addition, the value of R is preferably 40.0% or less, more preferably 30.0% or less, and still more preferably 20.0% or less, from the viewpoint of improving the chemical resistance.

In the present glass ceramic, a value of Q represented by the formula [Al₂O₃] /R is preferably 0.20 or more, more preferably 1.00 or more, still more preferably 1.50 or more, and most preferably 2.00 or more, from the viewpoint of reducing the mass change amount per surface area in the hot water immersion test. In addition, the value of Q is preferably 5.00 or less, more preferably 4.00 or less, and still more preferably 3.00 or less, from the viewpoint of improving the meltability during glass production.

MgO is a component that stabilizes the glass, and is also a component that improves mechanical strength and the weather resistance, and is therefore preferably contained. In the case where MgO is contained, the content of MgO is preferably 0.5% or more, more preferably 1.0% or more, still more preferably 2.0% or more, and particularly preferably 2.5% or more. On the other hand, when MgO is excessively added, a viscosity of the glass is lowered, and the devitrification or the phase separation is likely to occur, and therefore, the content of MgO is preferably 5% or less, more preferably 4.5% or less, still more preferably 4.0% or less, and particularly preferably 3.5% or less.

CaO is a component that improves the meltability of the glass and that improves the weather resistance, and is preferably contained. In the case where CaO is contained, the content of CaO is preferably 0.1% or more, more preferably 0.2% or more, still more preferably 0.4% or more, particularly preferably 0.6% or more, and most preferably 0.8% or more. On the other hand, when CaO is excessively added, an ion exchange rate may decrease, and therefore, the content of CaO is preferably 2.0% or less, more preferably 1.8% or less, still more preferably 1.6% or less, and particularly preferably 1.4% or less.

ZrO₂ is a component that improves the mechanical strength and that remarkably increases the CS in the case of ion exchange, and is therefore preferably contained. The content of ZrO₂ is preferably more than 0%, more preferably 0.5% or more, still more preferably 1.0% or more, even more preferably 1.5% or more, particularly preferably 2.0% or more, and most preferably 2.5% or more. On the other hand, the content of ZrO₂ is preferably 5.0% or less, more preferably 4.5% or less, still more preferably 4.0% or less, particularly preferably 3.5% or less, and most preferably 3.0% or less, in order to prevent devitrification during melting and deterioration of formability.

Y₂O₃ is a component having an effect of preventing fragments from scattering when a chemically strengthened glass is broken in the case of ion exchange, and may be contained. The content of Y₂O₃ is preferably 1.0% or more, more preferably 1.5% or more, still more preferably 2.0% or more, particularly preferably 2.5% or more, and extremely preferably 3.0% or more. On the other hand, the content of Y₂O₃ is preferably 5.0% or less, and more preferably 4.0% or less in order to prevent the devitrification during melting.

B₂O₃ is a component that improves chipping resistance of the glass and that improves the meltability, and may be contained. In the case where B₂O₃ is contained, the content thereof is preferably 0.5% or more, more preferably 1% or more, and still more preferably 2% or more in order to improve the meltability. On the other hand, when the content of B₂O₃ is too large, striae are generated during the melting or the phase separation is likely to occur, and thus a quality of the glass for chemical strengthening is likely to decrease, and therefore, the content is preferably 10% or less, more preferably 8% or less, still more preferably 6% or less, and particularly preferably 4% or less.

SnO₂ has an effect of promoting formation of a crystal nucleus and may be contained. In the case where SnO₂ is contained, the content of SnO₂ is preferably 0.5% or more, more preferably 1.0% or more, still more preferably 1.5% or more, and particularly preferably 2.0% or more. On the other hand, the content of SnO₂ is preferably 4.0% or less, more preferably 3.5% or less, still more preferably 3.0% or less, and particularly preferably 2.5% or less in order to prevent the devitrification during melting.

TiO₂ is a component capable of promoting the crystallization and may be contained. In the case where TiO₂ is contained, the content of TiO₂ is preferably 0.2% or more, and more preferably 0.5% or more. On the other hand, the content of TiO₂ is preferably 4% or less, more preferably 2% or less, and still more preferably 1% or less in order to prevent the devitrification during melting.

BaO, SrO, and ZnO may be contained in order to increase a refractive index of a residual glass to be close to a precipitated crystal phase, thereby improving a light transmittance of the glass ceramic. In this case, a total content of BaO, SrO, and ZnO (hereinafter, referred to as BaO+SrO+ZnO) is preferably 0.3% or more, more preferably 0.5% or more, still more preferably 0.7% or more, and particularly preferably 1% or more. On the other hand, these components may decrease the ion exchange rate. In order to improve the chemical strengthening properties, BaO+SrO+ZnO is preferably 2.5% or less, more preferably 2% or less, still more preferably 1.7% or less, and particularly preferably 1.5% or less.

La₂O₃, Nb₂O₅, and Ta₂O₅ are all components that prevent fragments from scattering when the chemically strengthened glass is broken, and may be contained in order to increase the refractive index. In the case where these components are contained, a total content of La₂O₃, Nb₂O₅, and Ta₂O₅ (hereinafter, referred to as La₂O₃+Nb₂O₅+Ta₂O₅) is preferably 0.5% or more, more preferably 1% or more, still more preferably 1.5% or more, and particularly preferably 2% or more. In addition, La₂O₃+Nb₂O₅+Ta₂O₅ is preferably 4% or less, more preferably 3% or less, still more preferably 2% or less, and particularly preferably 1% or less in order to prevent the devitrification of the glass during melting.

CeO₂ is a component that may prevent coloration by oxidizing the glass, and may be contained. In the case where CeO₂ is contained, the content of CeO₂ is preferably 0.03% or more, more preferably 0.05% or more, and still more preferably 0.07% or more. The content of CeO₂ is preferably 1.5% or less, and more preferably 1.0% or less in order to improve the transparency.

When the present glass ceramic is colored and used, a coloring component may be added within a range that does not impede achievement of desired chemical strengthening properties. Examples of the coloring component include Co₃O₄, MnO₂, Fe₂O₃, NiO, CuO, Cr₂O₃, V₂O₅, Bi₂O₃, SeO₂, Er₂O₃, and Nd₂O₃.

The total content of the coloring component is preferably in a range of 1% or less. In the case where it is desired to further increase a visible light transmittance of the glass, these components are preferably not substantially contained.

SO₃, a chloride, and a fluoride may be appropriately contained as a refining agent or the like during the melting of the glass. As₂O₃ is preferably not contained. In the case where As₂O₃ is contained, the content thereof is preferably 0.3% or less, more preferably 0.1% or less, and most preferably not contained.

### (Method for Producing Glass Ceramic)

A method for producing the present glass ceramic includes the following steps (A1) and (A2): (A1) a step of preparing an amorphous glass; and (A2) a step of subjecting the amorphous glass obtained in (A1) to a crystallization treatment to obtain a glass ceramic.

Hereinafter, the steps are described.

### [(A1) Step of Preparing Amorphous Glass]

The amorphous glass can be produced, for example, by the following method. Note that, the production method described below is an example of producing a sheet-shaped glass ceramic.

In order to obtain a glass having a preferred composition, glass raw materials are blended, and then heated and melted in a glass melting furnace. Thereafter, the molten glass is homogenized by bubbling, stirring, addition of a refining agent, and the like, and formed into a glass sheet having a predetermined thickness by a known forming method, followed by annealing. Alternatively, the molten glass may be formed into a block shape, followed by annealing, and then cut into a sheet shape.

### [(A2) Step of Subjecting Amorphous Glass Obtained in (A1) to Crystallization Treatment to Obtain Glass Ceramic]

In the step (A2), the amorphous glass obtained in the step (A1) is subjected to a heat treatment to precipitate crystals inside the glass, thereby obtaining a glass ceramic.

The heat treatment preferably includes a two-stage heat treatment in which 1) the glass is held for a certain period of time at a temperature raised from room temperature to a first treatment temperature, and 2) then is held for a certain period of time at a second treatment temperature that is higher than the first treatment temperature.

### 1) Heat Treatment at First Treatment Temperature

It is preferable that the heat treatment at the first treatment temperature is held at preferably 500° C. to 850° C., more preferably 520° C. to 800° C., and still more preferably 550° C. to 750° C. for preferably 1 hour to 6 hours, more preferably 2 hours to 5 hours, and still more preferably 3 hours to 4 hours.

By performing the heat treatment at the first treatment temperature at preferably 500° C. to 850° C. for preferably 1 hour to 6 hours in a relatively high temperature range, the formation of the crystal nucleus can be promoted to increase the crystallinity, and the mass change amount per surface area in the hot water immersion test can be reduced to further improve the weather resistance.
2) Heat Treatment at Second Treatment Temperature

It is preferable that the heat treatment at the second treatment temperature is held at preferably 600° C. to 1000° C., more preferably 650° C. to 950° C., and still more preferably 700° C. to 900° C. for preferably 0.2 hours to 10 hours, more preferably 2 hours to 8 hours, and still more preferably 3 hours to 6 hours.

By performing the heat treatment at the second treatment temperature at preferably 600° C. to 1000° C. for preferably 0.2 hours to 10 hours in a relatively high temperature range, the formation of the crystal nucleus can be promoted to increase the crystallinity, and the mass change amount per surface area in the hot water immersion test can be reduced to further improve the weather resistance.

### 2. Chemically Strengthened Glass Ceramic

In the present specification, the “chemically strengthened glass ceramic” refers to a glass in which a compressive stress layer is formed on the surface of a glass ceramic by subjecting the glass ceramic to an ion exchange treatment. The chemically strengthened glass ceramic according to the present embodiment (hereinafter, also referred to as the present chemically strengthened glass ceramic) is obtained by chemically strengthening the glass ceramic according to the present embodiment described above.

The present chemically strengthened glass ceramic contains, as a base composition in mol % in terms of oxides, 60% to 75% of SiO₂, 3% to 20% of Al₂O₃, and 5% to 25% of Li₂O, in which an average linear expansion coefficient at 250° C. to 350° C. is 90×10⁻⁷ [/K] or less, and when the present chemically strengthened glass ceramic is immersed in hot water at 80° C. for 120 minutes, a mass change amount per surface area is 8000 μg/cm² or less compared to a mass before immersion.

### (Mass Change Amount per Surface Area in Hot Water Immersion Test, and Mass Change Rate in Hot Water Immersion Test)

The present chemically strengthened glass ceramic has a mass change amount per surface area of 8000 μg/cm² or less when immersed in hot water at 80° C. for 120 minutes. When the mass change amount per surface area in the hot water immersion test is 8000 μg/cm² or less, the weather resistance can be improved, and a decrease in surface strength due to an environmental load can be prevented.

The mass change amount per surface area in the hot water immersion test for the present chemically strengthened glass ceramic is more preferably 6000 μg/cm² or less, still more preferably 3000 μg/cm² or less, particularly preferably 1000 μg/cm² or less, and most preferably 600 μg/cm² or less. The mass change amount per surface area in the hot water immersion test can be adjusted based on a linear expansion coefficient, a glass base composition, crystallization conditions, a crystal seed, a crystallinity, and the like.

### (Linear Expansion Coefficient)

The present chemically strengthened glass ceramic has an average linear expansion coefficient at 250° C. to 350° C. of 90×10⁻⁷ [/K] or less. Since the average linear expansion coefficient at 250° C. to 350° C. is 90×10⁻⁷ [/K] or less, the mass change amount per surface area in the hot water immersion test can be reduced, the weather resistance can be improved, and a decrease in surface strength due to an environmental load can be prevented. The average linear expansion coefficient at 250° C. to 350° C. is preferably 70×10⁻⁷ [/K] or less, more preferably 50×10⁻⁷ [/K] or less, still more preferably 30×10⁻⁷ [/K] or less, and particularly preferably 10×10⁻⁷ [/K] or less. The lower limit of the average linear expansion coefficient at 250° C. to 350° C. is not particularly limited. The average linear expansion coefficient at 250° C. to 350° C. can be adjusted based on the glass base composition, the crystallization conditions, the crystal seed, the crystallinity, and the like.

### (Young's Modulus)

The present chemically strengthened glass ceramic has a Young's modulus of preferably 70 GPa or more, more preferably 80 GPa or more, still more preferably 85 GPa or more, and particularly preferably 90 GPa or more. When the Young's modulus is 70 GPa or more, rigidity of the glass can be improved, and the strength can be increased. The Young's modulus is preferably 120 GPa or less, more preferably 110 GPa or less, and still more preferably 105 GPa or less, from the viewpoint of ease of polishing.

### (Surface Strength)

The surface strength of the present chemically strengthened glass ceramic after immersion in hot water at 80° C. for 120 minutes is preferably 450 N or more, more preferably 470 N or more, still more preferably 490 N or more, and particularly preferably 520 N or more. The upper limit of the surface strength after immersion in hot water at 80° C. for 120 minutes is not particularly limited.

### (Thickness and Shape)

A preferred thickness and a preferred shape of the present chemically strengthened glass ceramic are the same as the preferred thickness and the preferred shape of the present glass ceramic described above.

### (Base Composition, Crystal Seed, and Crystallinity of Chemically Strengthened Glass Ceramic)

A base composition of the present chemically strengthened glass ceramic is the same as the base composition of the present chemically strengthened glass described above, and a preferred composition range is also the same. In the case where the chemically strengthened glass ceramic has a sheet shape, a content proportion of an alkali metal element is different between a surface layer and a center in a thickness direction. On the other hand, the glass composition in the deepest portion from the surface of the chemically strengthened glass ceramic is the same as the base composition of the chemically strengthened glass ceramic except for a case where an extreme ion exchange treatment is performed. In the case where the chemically strengthened glass ceramic has a sheet shape, the deepest portion from the glass surface is, for example, a depth of ½ of the sheet thickness t.

A preferred crystal seed and crystallinity of the present chemically strengthened glass ceramic are the same as those of the present glass ceramic described above.

### (Method for Producing Chemically Strengthened Glass Ceramic)

A method for producing the present chemically strengthened glass ceramic includes the following steps (B1) to (B3). (B1) a step of preparing an amorphous glass, (B2) a step of subjecting the amorphous glass obtained in (B1) to a crystallization treatment to obtain a glass ceramic, and (B3) a step of subjecting the glass ceramic obtained in (B2) to a chemical strengthening treatment (ion exchange treatment) to obtain a chemically strengthened glass ceramic

The steps (B1) and (B2) are the same as the steps (A1) and (A2) described in the section of (Method for Producing Glass Ceramic), respectively. The step (B3) is described below. (B3) a step of subjecting the glass ceramic obtained in (B2) to a chemical strengthening treatment (ion exchange treatment) to obtain a chemically strengthened glass ceramic

In the present embodiment, the chemical strengthening treatment is performed, for example, by immersing the glass ceramic in a molten salt such as potassium nitrate preferably heated to 360° C. to 600° C. for preferably 0.1 hours to 500 hours. Note that, a heating temperature of the molten salt is preferably 360° C. to 600° C., and more preferably 375° C. to 500° C., and an immersion time of the glass ceramic in the molten salt is preferably 0.1 hours to 500 hours, and more preferably 0.3 hours to 200 hours.

Examples of the molten salt for performing the chemical strengthening treatment include a nitrate, a sulfate, a carbonate, and a chloride. Among them, examples of the nitrate include lithium nitrate, sodium nitrate, potassium nitrate, cesium nitrate, and silver nitrate. Examples of the sulfate include lithium sulfate, sodium sulfate, potassium sulfate, cesium sulfate, and silver sulfate. Examples of the carbonate include lithium carbonate, sodium carbonate, and potassium carbonate. Examples of the chloride include lithium chloride, sodium chloride, potassium chloride, cesium chloride, and silver chloride. These molten salts may be used alone or in combination of plural types thereof.

In the present embodiment, the treatment conditions of the chemical strengthening treatment may be appropriately selected in consideration of the properties and composition of the glass ceramic to be subjected to the chemical strengthening treatment, the type of the molten salt, chemical strengthening properties such as the surface compressive stress and the compressive stress layer depth desired for the chemically strengthened glass ceramic to be finally obtained, and the like.

In the present embodiment, the chemical strengthening treatment may be performed only once, or may be performed a plurality of times under two or more different conditions (multistage strengthening).

### (Stress Properties of Chemically Strengthened Glass Ceramic)

In the present specification, a “stress profile” represents a compressive stress value with the depth from the glass surface as a variable. In the stress profile, a tensile stress is expressed as a negative compressive stress.

The “compressive stress value (CS)” can be measured by slicing a cross section of a glass and analyzing the sliced sample with a birefringent imaging system. A birefringent imaging system birefringent stress meter is a device for measuring a magnitude of retardation caused by the stress by using a polarization microscope, a liquid crystal compensator, or the like, and for example, there is a birefringent imaging system Abrio-IM manufactured by CRi.

In order to acquire a stress profile of a glass in a non-destructive manner, for example, a scattered light photoelastic stress meter (hereinafter also abbreviated as an SLP), a glass film stress measurement (hereinafter also abbreviated as an FSM), or the like may be used in combination. As a stress profile in the glass surface layer and inside of the chemically strengthened glass, a combination of SLP information and FSM information is sometimes used.

For a glass ceramic (for example, a glass from which LiAlSi₂O₆ is precipitated), the stress can be measured using FSM after chemical strengthening. In a method using FSM, the compressive stress derived from Na-K exchange can be measured in a surface layer portion of the glass, which is at a depth of several tens of um or less from the glass surface (for example, WO 2018/056121 and WO 2017/115811). Examples of the film stress measurement include a glass film stress measurement FSM-6000 manufactured by Orihara Industrial Co., Ltd.

The stress at a deep layer portion may be measured using scattered light photoelasticity. In this method, light is incident from the glass surface, and polarization of scattered light thereof is analyzed to measure the CS. For example, a scattered light photoelastic stress meter SLP-2000 manufactured by Orihara Industrial Co., Ltd. is used as a stress measurement instrument using the scattered light photoelasticity.

In the present specification, the “compressive stress layer depth (DOC)” is a depth at

which the compressive stress value is zero. Hereinafter, a surface compressive stress value may be referred to as CS₀, and a compressive stress value at a depth of 50 μm may be referred to as CS₅₀. The surface compressive stress value CS₀ and the compressive stress layer depth DOC can be measured using a film stress measurement [for example, a film stress measurement (FSM-6000) manufactured by Orihara Industrial Co., Ltd.].

In the present specification, an “internal tensile stress value (CT)” refers to a tensile stress value at a depth of ½ of the sheet thickness t, and is equivalent to “CS_{t/2}” in the present specification.

The present chemically strengthened glass ceramic has a sheet thickness of t (mm) and a compressive stress layer depth DOC of preferably 0.14 t (μm) or more, more preferably 0.16 t (μm) or more, still more preferably 0.18 t (μm) or more, and particularly preferably 0.2 t (μm) or more. The DOC is preferably 0.14 t (μm) or more since the present chemically strengthened glass ceramic is less likely to crack even when the surface is scratched. The DOC is preferably 0.25 t (μm) or less in order to shorten the time required for chemical strengthening.

The present chemically strengthened glass ceramic preferably has a surface compressive stress value (CS₀) of 400 MPa or more since the present chemically strengthened glass ceramic is less likely to crack due to deformation such as deflection. The CS₀ is more preferably 450 MPa or more, still more preferably 500 MPa or more, and particularly preferably 600 MPa or more. The strength increases as the CS₀ increases, but in the case where the CS₀ is too large, severe crushing may occur during cracking, and therefore, the CS₀ is preferably 1400 MPa or less, and more preferably 1300 MPa or less.

The present chemically strengthened glass ceramic preferably has a sheet thickness of t (mm) and a compressive stress value CS₅₀ of 150 t (MPa) or more at a depth of 50 μm from the surface. The CS₅₀ is preferably 150 t (MPa) or more since it is easy to prevent the present chemically strengthened glass ceramic from cracking when a mobile terminal or the like having the present chemically strengthened glass ceramic as a cover glass is dropped. The CS₅₀ is more preferably 150 t+40 (MPa) or more, still more preferably 150 t+60 (MPa) or more, particularly preferably 150 t+80 (MPa) or more, and most preferably 150 t+100 (MPa) or more. The strength increases as the CS₅₀ increases, but in the case where the CS₅₀ is too large, severe crushing may occur during cracking, and therefore, the CS₅₀ is preferably 150 t+200 (MPa) or less.

The present chemically strengthened glass ceramic preferably has a sheet thickness of t (mm) and a tensile stress value CT of −350 t+400 (MPa) or less. When the tensile stress value CT is −350 t+400 (MPa) or less, the glass has higher durability against an external force or impact and is less likely to crack, and fragments are less likely to scatter even when the glass is cracked. The CT is more preferably −350 t+380 (MPa) or less, still more preferably −350 t+360 (MPa) or less, and particularly preferably −350 t+320 (MPa) or less. The CT is preferably −350t+260 (MPa) or more, and more preferably −350 t+280 (MPa) or more, from the viewpoint of the strength and the durability.

### 3. Application

The present glass ceramic and the present chemically strengthened glass ceramic are useful as a cover glass for use in an electronic device such as a mobile device such as a mobile phone or a smartphone. Further, the present glass ceramic and the present chemically strengthened glass ceramic are also useful for a cover glass of an electronic device such as a television, a personal computer, and a touch panel, an elevator wall surface, or a wall surface (full-screen display) of a construction such as a house and a building, which is not intended to be carried. In addition, the present glass ceramic and the present chemically strengthened glass ceramic are also useful as a building material such as a window glass, a table top, an interior of an automobile, an airplane, or the like, and a cover glass thereof, or useful for a casing having a curved surface shape.

### 4. Method for Testing Glass Ceramic

A method for testing the glass ceramic according to the present embodiment includes the following steps (C1) and (C2). (C1) a step of immersing a glass ceramic in hot water at 80° C. for 120 minutes to measure a mass change amount per surface area compared to a mass before immersion, and (C2) a step of determining that the glass ceramic is an acceptable product in the case where the mass change amount per surface area compared to the mass before immersion measured in (C1) is 1500 μg/cm² or less

### (C1) Step of Immersing Glass Ceramic in Hot Water at 80° C. for 120 Minutes to Measure Mass Change Amount Per Surface Area

The step (C1) is a step of measuring the mass change amount per surface area in the hot water immersion test. Specific conditions for the hot water immersion test include, for example, the following. Condition: a 50 mm×50 mm×0.7 mm glass is immersed in pure water at 80° C. for 120 minutes, the mass after immersion is subtracted from the mass before immersion to obtain the mass change amount and divide the obtained value by the surface area.

(C2) Step of Determining that Glass Ceramic is Acceptable Product in Case Where Mass Change Amount Per Surface Area Measured in (C1) is 1500 μg/cm² or Less

The step (C2) is a step of evaluating the glass based on the mass change amount per surface area measured in the step (C1). In the step (C2), the case where the mass change amount per surface area is 1500 μg/cm² or less is regarded as acceptable, and the case where the mass change amount per surface area is more than 1500 μg/cm² is regarded as unsuitable.

### 5. Method for Testing Chemically Strengthened Glass Ceramic

A method for testing the chemically strengthened glass ceramic according to the present embodiment includes the following steps (D1) and (D2). (D1) a step of immersing a chemically strengthened glass ceramic in hot water at 80° C. for 120 minutes to measure a mass change amount per surface area compared to a mass before immersion, and (D2) a step of determining that the chemically strengthened glass ceramic is an acceptable product in the case where the mass change amount per surface area compared to the mass before immersion measured in (D1) is 8000 μg/cm² or less

### (D1) Step of Immersing Chemically Strengthened Glass Ceramic in Hot Water at 80° C. for 120 Minutes to Measure Mass Change Amount Per Surface Area

The step (D1) is a step of measuring the mass change amount per surface area in the hot water immersion test. Specific conditions for the hot water immersion test include, for example, the following. Condition: a 50 mm×50 mm×0.7 mm glass is immersed in pure water at 80° C. for 120 minutes, the mass after immersion is subtracted from the mass before immersion to obtain the mass change amount and divide the obtained value by the surface area.

(D2) Step of Determining that Chemically Strengthened Glass Ceramic is Acceptable Product in Case Where Mass Change Amount Per Surface Area Measured in (D1) is 8000 μg/cm² or Less

The step (D2) is a step of evaluating the glass based on the mass change amount per surface area measured in the step (D1). In the step (D2), the case where the mass change amount per surface area is 8000 μg/cm² or less is regarded as acceptable, and the case where the mass change amount per surface area is more than 8000 μg/cm² is regarded as unsuitable.

As described above, the following configurations are disclosed in the present specification.
1. A glass ceramic having a base composition including, in mol % in terms of oxides, 60% to 75% of SiO₂, 3% to 20% of Al₂O₃, and 5% to 25% of Li₂O, in which
   an average linear expansion coefficient at 250° C. to 350° C. is 90×10⁻⁷ [/K] or less, and
   when the glass ceramic is immersed in hot water at 80° C. for 120 minutes, a mass change amount per surface area from a mass of the glass ceramic before immersion is 1500 μg/cm² or less.
2. The glass ceramic according to the above 1, including at least one selected from the group consisting of Li₂Si₂O₅, LiAlSi₂O₆, LiAlSi₄O₁₀, Li₃PO₄, and a β-quartz solid solution as a crystal seed.
3. The glass ceramic according to the above 1 or 2, in which a Young's modulus is 70 GPa or more.
4. The glass ceramic according to any one of the above 1 to 3, in which a mass change rate is 1000 ppm or less when the glass ceramic is immersed in hot water at 80° C. for 120 minutes.
5. The glass ceramic according to any one of the above 1 to 4, in which the base composition includes, in mol % in terms of oxides, 60% to 75% of SiO₂, 3% to 20% of Al₂O₃, more than 0% and 4.0% or less of P₂O₅, 5% to 25% of Li₂O, 0% to 2.0% of Na₂O, 0% to 1% of K₂O, 0% to 5% of MgO, 0% to 2% of CaO, and more than 0% and 5% or less of ZrO₂, in which
   X as determined using the following equation is 0.40 or less, provided that,

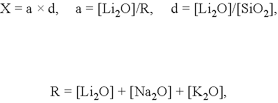

and
a value in [ ] indicates a content, in mol % in terms of oxides, of a component in the parentheses in the base composition.
6. A chemically strengthened glass ceramic having a base composition including, in mol % in terms of oxides, 60% to 75% of SiO₂, 3% to 20% of Al₂O₃, and 5% to 25% of Li₂O, in which
   an average linear expansion coefficient at 250° C. to 350° C. is 90×10⁻⁷ [/K] or less, and
   when the chemically strengthened glass ceramic is immersed in hot water at 80° C. for 120 minutes, a mass change amount per surface area from a mass of the chemically strengthened glass ceramic before immersion is 8000 μg/cm² or less.
7. The chemically strengthened glass ceramic according to the above 6, in which
   a sheet thickness is t (mm),
   a compressive stress layer depth DOC is 0.14 t (μm) or more,
   a surface compressive stress value CS₀ is 400 MPa or more,
   a compressive stress value CS₅₀ at a depth of 50 μm from a surface of the chemically strengthened glass ceramic is 150 t (MPa) or more, and
   a tensile stress value CT is −350 t+400 (MPa) or less.
8. The chemically strengthened glass ceramic according to the above 6 or 7, in which a Young's modulus is 70 GPa or more.
9. The chemically strengthened glass ceramic according to any one of the above 6 to 8, in which the base composition includes, in mol % in terms of oxides, 60% to 75% of SiO₂, 3% to 20% of Al₂O₃, more than 0% and 4.0% or less of P₂O₅, 5% to 25% of Li₂O, 0% to 2.0% of Na₂O, 0% to 1% of K₂O, 0% to 5% of MgO, 0% to 2% of CaO, and more than 0% and 5% or less of ZrO₂, in which
   X as determined using the following equation is 0.40 or less, provided that,

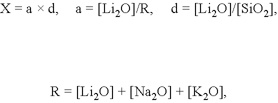

and
a value in [ ] indicates a content, in mol % in terms of oxides, of a component in the parentheses in the base composition.
10. A method for testing a glass ceramic, the method including:
   immersing a glass ceramic in hot water at 80° C. for 120 minutes to measure a mass change amount per surface area from a mass of the glass ceramic before immersion; and
   determining that the glass ceramic is an acceptable product in a case where the mass change amount per surface area is 1500 μg/cm² or less.
11. A method for testing a chemically strengthened glass ceramic, the method including:
   immersing a chemically strengthened glass ceramic in hot water at 80° C. for 120 minutes to measure a mass change amount per surface area from a mass of the chemically strengthened glass ceramic before immersion; and
   determining that the chemically strengthened glass ceramic is an acceptable product in a case where the mass change amount per surface area is 8000 μg/cm² or less.

Hereinafter, the present invention is described with reference to Examples, but the present invention is not limited thereto.

### EXAMPLES

### [Evaluation Method] (Young's Modulus E)

Measurement was performed by using an ultrasonic method.

### (Fracture Toughness Value K_{IC})

Measurement was performed by using an IF method in accordance with JIS R1607:2015.

### (Hot Water Immersion Test)

The pure water was heated to 80° C. to prepare hot water, and the glass (two test pieces each) was immersed in the hot water. The immersion time was set to 30 minutes or 120 minutes, and the glass masses before and after the immersion were measured to determine the mass change amount per surface area and the mass change rate.

In Table 3, the “mass change amount (μg/cm²) per surface area in hot water immersion test” indicates a mass change amount per surface area compared to the mass before immersion when immersed in hot water at 80° C. for 120 minutes.

In Table 3, the “mass change rate (ppm) in hot water immersion test” is shown. The mass change rate compared to the mass before immersion in hot water at 80° C. for 120 minutes is shown.

### (Average Linear Expansion Coefficient at 250° C. to 350° C.)

The linear expansion coefficient (α) was measured using a differential thermal dilatometer (TMA) and was determined based on the standard in JIS R3102 (1995).

### (Surface Strength)

The surface strength of the glass was measured by a ball on ring strength test. FIG. 4 is a schematic diagram illustrating the ball on ring strength test. In the state where the glass sheet 1 was placed horizontally, the glass sheet was pressurized using the SUS304-made pressurizing jig 2 (quenched steel, diameter: 10 mm, mirror finished), and the surface strength of the glass sheet was measured. In FIG. 4, the glass plate as a sample is horizontally placed on the SUS304-made receiving jig 3 (diameter: 30 mm, curvature R of contact portion: 2.5 mm, contact portion: quenched steel, mirror-finished). The pressurizing jig 2 for pressurizing the glass sheet is installed above the glass sheet. The central region of the glass sheet was pressurized from above the obtained glass sheet. At this time, the breaking load (unit: N) when the glass sheet was broken was defined as the BoR surface strength, and the average value of the measurements ten times was defined as the surface strength. However, in the case where the breaking starting point of the glass sheet was 2 mm or more away from the ball pressing position, it was excluded from the data for calculating the average value. Note that, the test conditions were as follows.
Lowering speed of pressurizing jig: 1.0 (mm/min)

### (X-ray Diffraction: Identification of Precipitated Crystals)

Powder X-ray diffraction was measured under the following conditions to identify the precipitated crystal.
Measurement device: Smart Lab manufactured by Rigaku Corporation
X-ray used: CuKα ray
Measurement range: 2θ=10° to 80°
Speed: 1°/min
Step: 0.01° (crystallinity)
The powder X-ray diffraction was measured under the following conditions, and the crystallinity [unit: %] was calculated using the Rietveld method.
Measurement device: Smart Lab manufactured by Rigaku Corporation
X-ray used: CuKα rays
Measurement range: 2θ=10° to 80°
Speed: 10°/min
Step: 0.02°

### (Stress Profile)

The stress profile was measured using the scattered light photoelastic stress meter SLP-2000 manufactured by Orihara Industrial Co., Ltd.

### Reference Example 1

As shown in Table 1, glass materials having different compositions and crystal seeds (amorphous glass or glass ceramic, 50 mm×50 mm×0.7 mm) were prepared and immersed in hot water at 80° C. (immersion time in hot water: 30 minutes or 120 minutes), and the mass change amount per surface area compared with the mass before immersion was measured. After immersion in hot water at 80° C. for 120 minutes, the surface strength was measured by using the BoR strength test. FIG. 1 shows the mass change amount per surface area compared to the mass before immersion when the glass is immersed in hot water (immersion time in hot water: 30 minutes or 120 minutes). FIG. 2 and Table 2 show results of measuring the surface strength by using the BoR strength test after the glass material is immersed in hot water at 80° C. for 120 minutes.

TABLE 1

| | Glass | |
|---|---|---|
| Composition | material type | Crystal seed |
| A | Glass ceramic | Li₂SiO₃ |
| B | Glass ceramic | Li₃PO₄ |
| C | Glass ceramic | LiAlSi₄O₁₀ |
| D | Amorphous glass | Not contained |

TABLE 2

| Composition | A | B | C |
|---|---|---|---|
| Glass type | Glass ceramic | Glass ceramic | Glass ceramic |
| Crystal seed | Li₂SiO₃ | Li₃PO₄ | LiAlSi₄O₁₀ |
| Surface strength (MPa) | 400 | 380 | 410 |
| before immersion in | | | |
| hot water | | | |
| Surface strength (MPa) | 100 | 390 | 400 |
| after immersion in | | | |
| hot water at 80° C. | | | |
| for 120 minutes | | | |

As shown in FIG. 1, it can be seen that the mass change amount per surface area when the glass is immersed in hot water varies depending on the composition and the structure of the glass material (a glass ceramic or an amorphous glass, or a crystal seed contained in the glass ceramic), and the mass change amount of the glass ceramic is larger than that of the amorphous glass. As shown in FIG. 2 and Table 2, in a glass material A in which the mass change amount per surface area when immersed in hot water at 80° C. for 120 minutes compared to the mass before immersion is large, the surface strength after immersion significantly decreases. As seen from these results, there is a correlation between the mass change amount per surface area when the glass is immersed in hot water at 80° C. for 120 minutes compared to the mass before immersion and the surface strength when an environmental load is applied to the glass.

### Test Example 1

### (1) Preparation and Evaluation of Amorphous Glass

Glass raw materials were blended so as to have the glass composition shown in Table 3 in mol % in terms of oxides, and weighed to obtain 800 g of glass. Next, the mixed glass raw materials were charged into a platinum crucible, followed by charging into an electric furnace at 1600° C., melted for about 5 hours, defoamed, and homogenized.

The obtained molten glass was poured into a mold, maintained at a temperature of the glass transition point for 1 hour, and then cooled to room temperature at a rate of 0.5° C./min, to obtain a glass block. The obtained glass block was processed into 50 mm×50 mm×0.7 mm and analyzed.

### (2) Preparation and Evaluation of Glass Ceramic

In Examples 2 to 11, the amorphous glass obtained in the above (1) was subjected to a heat treatment under the conditions shown in Table 3 to obtain a glass ceramic. The crystallization conditions were set to two stages, and after the treatment at the first treatment temperature was performed at a temperature and time of a nucleation treatment shown in Table 3, the treatment at the second treatment temperature was performed at a temperature and time of a nucleus growth treatment.

The obtained glass ceramic was processed and mirror-polished to obtain a glass ceramic sheet having a thickness t of 0.7 mm, which was then analyzed. In addition, a rod-shaped sample for measuring the linear expansion coefficient was prepared. A part of the remaining glass ceramic was pulverized and used for analysis of precipitated crystals. Table 3 shows, for the glass ceramic, the results of evaluating the average linear expansion coefficient at 250° C. to 350° C., the crystallinity, the crystal seed, the mass change amount per surface area and the mass change rate in the hot water immersion test, and the surface strength measured by using the BoR strength test after immersion in hot water at 80° C. for 120 minutes.

### (3) Preparation and Evaluation of Chemically Strengthened Glass or Chemically Strengthened Glass Ceramic

The amorphous glass obtained in the above (1) or the glass ceramic obtained in the above (2) was immersed in a sodium nitrate molten salt at 400° C. for 60 minutes, then the glass was washed with water, dried, and then immersed in a potassium nitrate molten salt at 400° C. for 60 minutes to perform ion exchange, thereby preparing a chemically strengthened glass or a chemically strengthened glass ceramic, which was then analyzed.

Table 3 shows the results of analyzing the amorphous glass, the glass ceramic, the chemically strengthened glass, and the chemically strengthened glass ceramic. In Table 3, Examples 1 to 4 are Comparative Examples, and Examples 5 to 11 are Inventive Examples.

TABLE 3

| | | Ex. 1 | Ex. 2 | Ex. 3 | Ex. 4 | Ex. 5 | Ex. 6 |
|---|---|---|---|---|---|---|---|
| Composition | SiO₂ | 66.0 | 55.0 | 50.0 | 51.0 | 68.0 | 68.0 |
| (mol %) | Al₂O₃ | 12.0 | 6.0 | 5.0 | 6.0 | 10.0 | 12.0 |
| | P₂O₅ | 0.0 | 2.0 | 2.3 | 2.0 | 0.5 | 0.5 |
| | Y₂O₃ | 1.5 | 1.0 | 1.0 | 1.0 | 0.0 | 0.0 |
| | Li₂O | 11.0 | 30.0 | 34.0 | 34.0 | 17.0 | 15.0 |
| | Na₂O | 5.0 | 1.8 | 1.8 | 1.8 | 1.5 | 1.5 |
| | K₂O | 3.0 | 0.0 | 1.2 | 0.0 | 0.8 | 0.8 |
| | MgO | 0.7 | 0.0 | 0.0 | 0.0 | 0.1 | 0.1 |
| | CaO | 0.2 | 0.1 | 0.1 | 0.1 | 0.1 | 0.1 |
| | SrO | 0.0 | 0.1 | 0.1 | 0.1 | 0.0 | 0.0 |
| | ZrO₂ | 0.5 | 4.0 | 4.5 | 4.0 | 1.0 | 1.5 |
| | TiO₂ | 0.1 | 0.0 | 0.0 | 0.0 | 0.0 | 0.0 |
| | SnO₂ | 0.0 | 0.0 | 0.0 | 0.0 | 1.0 | 0.5 |
| | Fe₂O3 | 0.0 | 0.0 | 0.0 | 0.0 | 0.0 | 0.0 |
| | SUM | 100 | 100 | 100 | 100 | 100 | 100 |
| R = Li₂O + Na₂O + K₂O | | 19.0 | 31.8 | 37.0 | 35.8 | 19.3 | 17.3 |
| a = Li₂O/R | | 0.58 | 0.94 | 0.92 | 0.95 | 0.88 | 0.87 |
| b = Na₂O/R | | 0.26 | 0.06 | 0.05 | 0.05 | 0.08 | 0.09 |
| c = K₂O/R | | 0.16 | 0.00 | 0.03 | 0.00 | 0.04 | 0.05 |
| d = Li₂O/SiO₂ | | 0.17 | 0.55 | 0.68 | 0.67 | 0.25 | 0.22 |
| X = a × d | | 0.10 | 0.51 | 0.62 | 0.63 | 0.22 | 0.19 |
| Q = Al₂O₃/R | | 0.63 | 0.19 | 0.14 | 0.17 | 0.52 | 0.69 |
| S = a × b × c | | 0.024 | 0.000 | 0.001 | 0.000 | 0.003 | 0.003 |
| Main crystal | | No | Li₂SiO₃ | Li₂SiO₃ | Li₂SiO₃ | LiAlSi₂O₆ | LiAlSi₂O₆ |
| Si/Li ratio in main crystal | | 0.0 | 0.5 | 0.5 | 0.5 | 2.0 | 2.0 |
| Al/Li ratio in main crystal | | 0 | 0 | 0 | 0 | 1 | 1 |
| Nucleation temperature (° C.) | | — | 550 | 550 | 550 | 700 | 700 |
| Nucleation time (h) | | — | 2 | 2 | 2 | 4 | 4 |
| Nucleus growth temperature (° C.) | | — | 750 | 750 | 750 | 900 | 900 |
| Nucleus growth time (h) | | — | 2 | 2 | 2 | 3 | 3 |
| Crystallinity (%) | | — | 80 | 82 | 78 | 90 | 90 |
| K_{IC} (MPa · m^{1/2}) | | 0.80 | 0.92 | 0.92 | 0.93 | 0.85 | 0.85 |
| Young's modulus (GPa) | | 85 | 95 | 94 | 95 | 88 | 88 |
| Sheet Thickness (mm) | | 0.7 | 0.7 | 0.7 | 0.7 | 0.7 | 0.7 |
| Before | Mass change rate (ppm) in | 20 | 832 | 1097 | 1235 | 26 | 20 |
| chemical | hot water immersion test | | | | | | |
| strength- | Mass change amount per | 40 | 1630 | 2150 | 2420 | 50 | 40 |
| ening | surface area (μg/cm²) in | | | | | | |
| | hot water immersion test | | | | | | |
| | Linear expansion | 79 | — | 123 | 140 | 40 | 30 |
| | coefficient × 10⁻⁷ [/K] | | | | | | |
| | Surface strength (N) after | 330 | — | 280 | 290 | 360 | — |
| | immersion in hot water at | | | | | | |
| | 80° C. for 120 minutes | | | | | | |
| After | Mass change rate (ppm) in | 190 | — | 4800 | 5600 | 306 | — |
| chemical | hot water immersion test | | | | | | |
| strength- | Mass change amount per | 360 | — | 9500 | 11000 | 600 | — |
| ening | surface area (μg/cm²) in | | | | | | |
| | hot water immersion test | | | | | | |
| | Linear expansion | 79 | — | 123 | 140 | 40 | 30 |
| | coefficient × 10⁻⁷ [/K] | | | | | | |
| | Surface strength (N) after | 440 | — | 360 | 350 | 480 | — |
| | immersion in hot water at | | | | | | |
| | 80° C. for 120 minutes | | | | | | |
| | DOC (μm) | 103 | — | 68 | — | 90 | — |
| | CS₀ (MPa) | 1183 | — | 900 | — | 1250 | — |
| | CS₃₀ (MPa) | 148 | — | 293 | — | 320 | — |
| | CS₅₀ (MPa) | 95 | — | 104 | — | 140 | — |
| | CS₉₀ (MPa) | 17 | — | −47 | — | 0 | — |
| | CT (MPa) | 54 | — | 55 | — | 80 | — |

| | | Ex. 7 | Ex. 8 | Ex. 9 | Ex. 10 | Ex. 11 |
|---|---|---|---|---|---|---|
| Composition | SiO₂ | 68.0 | 67.0 | 67.0 | 69.5 | 68.0 |
| (mol %) | Al₂O₃ | 14.0 | 17.5 | 20.0 | 20.0 | 5.0 |
| | P₂O₅ | 0.5 | 0.5 | 0.5 | 0.5 | 1.5 |
| | Y₂O₃ | 0.0 | 0.0 | 0.0 | 0.0 | 0.0 |
| | Li₂O | 13.0 | 10.0 | 7.5 | 5.0 | 24.0 |
| | Na₂O | 1.5 | 1.5 | 1.5 | 1.5 | 0.0 |
| | K₂O | 0.8 | 0.8 | 0.8 | 0.8 | 0.0 |
| | MgO | 0.1 | 0.1 | 0.1 | 0.1 | 0.0 |
| | CaO | 0.1 | 0.1 | 0.1 | 0.1 | 0.0 |
| | SrO | 0.0 | 0.0 | 0.0 | 0.0 | 0.0 |
| | ZrO₂ | 1.5 | 1.5 | 1.5 | 1.5 | 1.0 |
| | TiO₂ | 0.0 | 0.0 | 0.0 | 0.0 | 0.0 |
| | SnO₂ | 0.5 | 1.0 | 1.0 | 1.0 | 0.5 |
| | Fe₂O3 | 0.0 | 0.0 | 0.0 | 0.0 | 0.0 |
| | SUM | 100 | 100 | 100 | 100 | 100 |
| R = Li₂O + Na₂O + K₂O | | 15.3 | 12.3 | 9.8 | 7.3 | 24.0 |
| a = Li₂O/R | | 0.85 | 0.81 | 0.77 | 0.68 | 1.00 |
| b = Na₂O/R | | 0.10 | 0.12 | 0.15 | 0.21 | 0.00 |
| c = K₂O/R | | 0.05 | 0.07 | 0.08 | 0.11 | 0.00 |
| d = Li₂O/SiO₂ | | 0.19 | 0.15 | 0.11 | 0.07 | 0.35 |
| X = a × d | | 0.16 | 0.12 | 0.09 | 0.05 | 0.35 |
| Q = Al₂O₃/R | | 0.92 | 1.42 | 2.04 | 2.74 | 0.21 |
| S = a × b × c | | 0.004 | 0.006 | 0.010 | 0.015 | 0.000 |
| Main crystal | | LiAlSi₂O₆ | LiAlSi₂O₆ | LiAlSi₂O₆ | LiAlSi₂O₆ | β-Quartz |
| | | | | | | solid |
| | | | | | | solution |
| Si/Li ratio in main crystal | | 2.0 | 2.0 | 2.0 | 2.0 | 1.0 |
| Al/Li ratio in main crystal | | 1 | 1 | 1 | 1 | 0 |
| Nucleation temperature (° C.) | | 700 | 700 | 700 | 700 | 700 |
| Nucleation time (h) | | 4 | 4 | 4 | 4 | 4 |
| Nucleus growth temperature (° C.) | | 900 | 900 | 900 | 900 | 900 |
| Nucleus growth time (h) | | 3 | 3 | 3 | 3 | 0.3 |
| Crystallinity (%) | | 92 | 90 | 90 | 90 | 60 |
| K_{IC} (MPa · m^{1/2}) | | 0.85 | 0.85 | 0.83 | 0.81 | 0.73 |
| Young's modulus (GPa) | | 88 | 87 | 86 | 85 | 76 |
| Sheet Thickness (mm) | | 0.7 | 0.7 | 0.7 | 0.7 | 0.7 |
| Before | Mass change rate (ppm) in | 15 | 13 | 10 | 8 | 9 |
| chemical | hot water immersion test | | | | | |
| strength- | Mass change amount per | 30 | 25 | 20 | 15 | 18 |
| ening | surface area (μg/cm²) in | | | | | |
| | hot water immersion test | | | | | |
| | Linear expansion | 27 | 20 | 15 | 18 | 5 |
| | coefficient × 10⁻⁷ [/K] | | | | | |
| | Surface strength (N) after | 380 | — | 370 | — | 370 |
| | immersion in hot water at | | | | | |
| | 80° C. for 120 minutes | | | | | |
| After | Mass change rate (ppm) in | 260 | — | 230 | — | 205 |
| chemical | hot water immersion test | | | | | |
| strength- | Mass change amount per | 500 | — | 450 | — | 400 |
| ening | surface area (μg/cm²) in | | | | | |
| | hot water immersion test | | | | | |
| | Linear expansion | 27 | 20 | 15 | 18 | 5 |
| | coefficient × 10⁻⁷ [/K] | | | | | |
| | Surface strength (N) after | 550 | — | 480 | — | 520 |
| | immersion in hot water at | | | | | |
| | 80° C. for 120 minutes | | | | | |
| | DOC (μm) | 77 | — | 80 | — | 110 |
| | CS₀ (MPa) | 1270 | — | 1200 | — | 400 |
| | CS₃₀ (MPa) | 251 | — | 220 | — | 50 |
| | CS₅₀ (MPa) | 123 | — | 110 | — | 40 |
| | CS₉₀ (MPa) | −32 | — | −20 | — | 30 |
| | CT (MPa) | 70 | — | 60 | — | 30 |

As shown in Table 3, it can be seen that the glass ceramics in Examples 5, 7, 9, and 11, in which the average linear expansion coefficient at 250° C. to 350° C. is 90×10⁻⁷ [/K] or less and the mass change amount per surface area in the hot water immersion test is 1500 μg/cm² or less compared to the mass before immersion, have higher surface strength after immersion in hot water at 80° C. for 120 minutes, have excellent weather resistance, and are less likely to deteriorate in surface state due to an environmental load, compared to the amorphous glass in Example 1 and the glass ceramics in Examples 3 and 4, which are Comparative Examples.

In addition, it can be seen that the chemically strengthened glass ceramics in Examples 5, 7, 9, and 11 which are Inventive Examples and in which the average linear expansion coefficient at 250° C. to 350° C. is 90×10⁻⁷ [/K] or less and the mass change amount per surface area in the hot water immersion test is 8000 μg/cm² or less compared to the mass before immersion, have higher surface strength after immersion in hot water at 80° C. for 120 minutes, have excellent weather resistance, and are less likely to deteriorate in surface state due to an environmental load, compared to the chemically strengthened glasses in Example 1 and the chemically strengthened glass ceramics in Examples 3 and 4, which are Comparative Examples.

The present invention has been described in detail with reference to a specific mode, but it will be apparent to those skilled in the art that various changes and modifications can be made without departing from the spirit and scope of the present invention. The present application is based on Japanese Patent Application No. 2024-085839 filed on May 27, 2024, and the entirety of which is incorporated herein by reference.

What is claimed is:

1. A glass ceramic having a base composition comprising, in mol % in terms of oxides, 60% to 75% of SiO₂, 3% to 20% of Al₂O₃, and 5% to 25% of Li₂O, wherein an average linear expansion coefficient at 250° C. to 350° C. is 90×10⁻⁷ [/K] or less, and
when the glass ceramic is immersed in hot water at 80° C. for 120 minutes, a mass change amount per surface area from a mass of the glass ceramic before immersion is 1500 μg/cm² or less.

2. The glass ceramic according to claim 1, comprising at least one selected from the group consisting of Li₂Si₂O₅, LiAlSi₂O₆, LiAlSi₄O₁₀, Li₃PO₄, and a β-quartz solid solution as a crystal seed.

3. The glass ceramic according to claim 1, wherein a Young's modulus is 70 GPa or more.

4. The glass ceramic according to claim 1, wherein a mass change rate is 1000 ppm or less when the glass ceramic is immersed in hot water at 80° C. for 120 minutes.

5. The glass ceramic according to claim 1, wherein the base composition comprises, in mol % in terms of oxides, 60% to 75% of SiO₂, 3% to 20% of Al₂O₃, more than 0% and 4.0% or less of P₂O₅, 5% to 25% of Li₂O, 0% to 2.0% of Na₂O, 0% to 1% of K₂O, 0% to 5% of MgO, 0% to 2% of CaO, and more than 0% and 5% or less of ZrO₂, wherein
X as determined using the following equation is 0.40 or less, provided that, 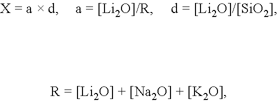
and
a value in [ ] indicates a content, in mol % in terms of oxides, of a component in the parentheses in the base composition.

6. A chemically strengthened glass ceramic having a base composition comprising, in mol % in terms of oxides, 60% to 75% of SiO₂, 3% to 20% of Al₂O₃, and 5% to 25% of Li₂O, wherein an average linear expansion coefficient at 250° C. to 350° C. is 90×10⁻⁷ [/K] or less, and when the chemically strengthened glass ceramic is immersed in hot water at 80° C. for 120 minutes, a mass change amount per surface area from a mass of the chemically strengthened glass ceramic before immersion is 8000 μg/cm² or less.

7. The chemically strengthened glass ceramic according to claim 6, wherein
a sheet thickness is t (mm),
a compressive stress layer depth DOC is 0.14 t (μm) or more,
a surface compressive stress value CS₀ is 400 MPa or more,
a compressive stress value CS₅₀ at a depth of 50 μm from a surface of the chemically strengthened glass ceramic is 150 t (MPa) or more, and
a tensile stress value CT is −350 t+400 (MPa) or less.

8. The chemically strengthened glass ceramic according to claim 6, wherein a Young's modulus is 70 GPa or more.

9. The chemically strengthened glass ceramic according to claim 6, wherein the base composition comprises, in mol % in terms of oxides, 60% to 75% of SiO₂, 3% to 20% of Al₂O₃, more than 0% and 4.0% or less of P₂O₅, 5% to 25% of Li₂O, 0% to 2.0% of Na₂O, 0% to 1% of K₂O, 0% to 5% of MgO, 0% to 2% of CaO, and more than 0% and 5% or less of ZrO₂, wherein
X as determined using the following equation is 0.40 or less, provided that, 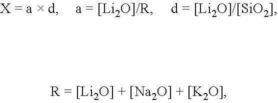
and
a value in [ ] indicates a content, in mol % in terms of oxides, of a component in the parentheses in the base composition.

10. A method for testing a glass ceramic, the method comprising:
immersing a glass ceramic in hot water at 80° C. for 120 minutes to measure a mass change amount per surface area from a mass of the glass ceramic before immersion; and
determining that the glass ceramic is an acceptable product in a case where the mass change amount per surface area is 1500 μg/cm² or less.

11. A method for testing a chemically strengthened glass ceramic, the method comprising:
immersing a chemically strengthened glass ceramic in hot water at 80° C. for 120 minutes to measure a mass change amount per surface area from a mass of the chemically strengthened glass ceramic before immersion; and
determining that the chemically strengthened glass ceramic is an acceptable product in a case where the mass change amount per surface area is 8000 μg/cm² or less.
